(19) United States
(12) Patent Application Publication
(10) Pub. No.: US 2013/0058807 A1
(43) Pub. Date: Mar. 7, 2013

(54) Miniature Motor and Cooling Fan Having the Same

(71) Applicants: Duo-Nian Shan, Kaohsiung (TW); Yuan-Jie Zheng, Kaohsiung (TW)

(72) Inventors: Duo-Nian Shan, Kaohsiung (TW); Yuan-Jie Zheng, Kaohsiung (TW)

(21) Appl. No.: 13/242,191

(22) Filed: Sep. 23, 2011

(30) Foreign Application Priority Data
Sep. 1, 2011 (TW) 100131557

(51) Int. Cl. F04B 35/04; H02K 5/00

(52) U.S. Cl. 417/410.1; 310/40 MM

(57) ABSTRACT

A miniature motor includes a base having a coupling portion. An engaging portion is provided on a periphery of the base surrounding the coupling portion to form a concave surface therebetween. A stator coil unit includes a substrate mounted on the concave surface. A rotating member is rotatably coupled with the coupling portion and includes a permanent magnet. The base includes a thermoplastic section having a reduced opening. The reduced opening is formed by heating and deforming the thermoplastic section after the stator coil unit is mounted on the concave surface, and the molten and deformed thermoplastic section takes shape to form the reduced opening after cooling. The base can be connected to a frame having an air inlet and an air outlet to form a fan housing, and the rotating member includes blades to form an impeller, providing a cooling fan including the miniature motor.

### BACKGROUND OF THE INVENTION

1. Field of the Invention

The present invention relates to a miniature motor and a cooling fan having the miniature motor and, more particularly, to a miniature motor allowing easy assembly and reliable engagement of a stator coil unit and a cooling fan having the miniature motor.

2. Description of the Related Art

FIG. 1 shows a conventional fan 8 including a base 81. A cylindrical seat 811 is integrally formed on a central portion of the base 81. A flange 812 is formed around the cylindrical seat 811. A plurality of protrusions 813 is formed on an inner periphery of the flange 812. The protrusions 813 can be coupled with members such as a circuit board 82 and a stator 83. An example of such a fan 8 is disclosed in Taiwan Utility Model No. 317321 entitled “FAN STRUCTURE INCLUDING GAPS BETWEEN AN OILY BEARING AND A COIL”.

However, the protrusions 813 can not provide reliable positioning for the circuit board 82 and the stator 83. The overall positioning effect is not satisfactory, because no additional disengagement preventing provision is provided. Thus, the circuit board 82 and the stator 83 are liable to disengage from the base 81. Furthermore, the circuit board 82 and the stator 83 are generally mounted to the inner periphery of the flange 812 by tight fitting that is liable to cause damage to the protrusions 813 while providing poor assembling convenience.

FIG. 2 shows a conventional miniature motor 9 including a base 91 having a shaft tube 911 at a center thereof for engagement with a printed circuit board 92 and a coil 93. The base 91 further includes a plurality of upright coil positioning pegs 94 around the shaft tube 911. After extending the coil positioning pegs 94 through through-holes in the printed circuit board 92 and the coil 93, heating or gluing is carried out on a top end of each coil positioning pegs 94. An example of such a miniature motor 9 is disclosed in Taiwan Invention Patent No. 1320688 entitled “FIXING STRUCTURE FOR A PRINTED CIRCUIT BOARD OF A MINIATURE MOTOR”.

However, the coil positioning pegs 94 must be accurately aligned with the through-holes of the printed circuit board 92 and the coil 93 before the subsequent heating or gluing on the top ends of the coil positioning pegs 94, failing to provide assembling convenience. Furthermore, the printed circuit board 92 and the coil 93 are fixed only by the coil positioning pegs 94 that are apt to break or damage. Further, the engagement reliability between the coil positioning pegs 94 and the printed circuit board 92/coil 93 is also poor. Improvement is, thus, required.

### SUMMARY OF THE INVENTION

An objective of the present invention is to provide a miniature motor that allows easy, convenient assembly of a stator coil unit.

Another objective of the present invention is to provide a miniature motor that assures reliable engagement of the stator coil unit.

A further objective of the present invention is to provide a cooling fan including a miniature motor to enhance assembling convenience while providing enhanced disengagement preventing effect.

According to a first aspect, a miniature motor includes a base having a coupling portion. An engaging portion is provided on a periphery of the base surrounding the coupling portion. A concave surface is formed between the coupling portion and the engaging portion. The engaging portion includes an end having a thermoplastic section. A stator coil unit includes a substrate mounted on the concave surface of the base. The substrate includes at least one coil. A rotating member is rotatably coupled with the coupling portion of the base and includes a permanent magnet, with an air gap formed between the permanent magnet and the stator coil unit. The thermoplastic section of the base includes a reduced opening. The reduced opening is formed by heating and deforming the thermoplastic section after the stator coil unit is mounted on the concave surface, and the molten and deformed thermoplastic section takes shape to form the reduced opening after cooling.

According to a second aspect, a cooling fan includes a base having a coupling portion. The base is connected to a frame to form a fan housing. The frame includes an air inlet and an air outlet. An engaging portion is provided on a periphery of the base surrounding the coupling portion. A concave surface is formed between the coupling portion and the engaging portion. The engaging portion includes an end having a thermoplastic section. A stator coil unit includes a substrate mounted on the concave surface of the base. The substrate includes at least one coil. A rotating member is rotatably coupled with the coupling portion of the base and includes a permanent magnet, with an air gap formed between the permanent magnet and the stator coil unit. The rotating member includes a plurality of blades to form an impeller. The thermoplastic section of the base includes a reduced opening. The reduced opening is formed by heating and deforming the thermoplastic section after the stator coil unit is mounted on the concave surface, and the molten and deformed thermoplastic section takes shape to form the reduced opening after cooling.

The base is connected to the frame by a plurality of connecting members.

The at least one coil of the stator coil unit is electrically connected to a power connection unit. One of the plurality of connecting members includes an auxiliary engaging portion having a second thermoplastic section. The second thermoplastic section of the auxiliary engaging portion includes a second reduced opening. The second reduced opening of the auxiliary engaging portion retains the power connection unit and has a width smaller than a width of the power connection unit.

The auxiliary engaging portion includes two retaining plates spaced from each other. The power connection unit is clamped between the two retaining plates of the auxiliary engaging portion.

The one of the plurality of connecting members includes two clamping plates. The two clamping plates clamp and fix the power connection unit.

The engaging portion is an annular wall surrounding the substrate of the stator coil unit.

The engaging portion includes a plurality of grooves. A limiting plate is formed between two adjacent grooves. The limiting plates surround and clamp the substrate of the stator coil unit.

The engaging portion of the base includes an inner peripheral wall facing the coupling portion. The inner peripheral wall is a pressing face. The substrate includes an outer periphery engaged with the pressing face.

The reduced opening has a diameter smaller than the maximum diameter of the stator coil unit.

The substrate of the stator coil unit includes a mounting hole, and the coupling portion of the base extends through the mounting hole.

The engaging portion includes a notch. The stator coil unit includes an electrical connection port electrically connected to the at least one coil. The electrical connection port is engaged in the notch of the engaging portion.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows an exploded, perspective view of a conventional fan.

FIG. 2 shows a cross sectional view of a conventional miniature motor.

FIG. 3 shows an exploded, perspective view of a miniature fan according to the present invention.

FIG. 4 shows a schematic cross sectional view illustrating assembly of the miniature fan according to the present invention.

FIG. 5 shows a cross sectional view of the miniature fan according to the present invention after assembly.

FIG. 5A shows an enlarged view of a circled portion in FIG. 5.

FIG. 6 shows a perspective view of a miniature motor of another embodiment according to the present invention.

FIG. 7 shows an exploded perspective view of a cooling fan having the miniature motor of FIG. 6.

FIG. 8 shows a cross sectional view of the cooling fan of FIG. 7.

FIG. 9 shows a circled portion of FIG. 8.

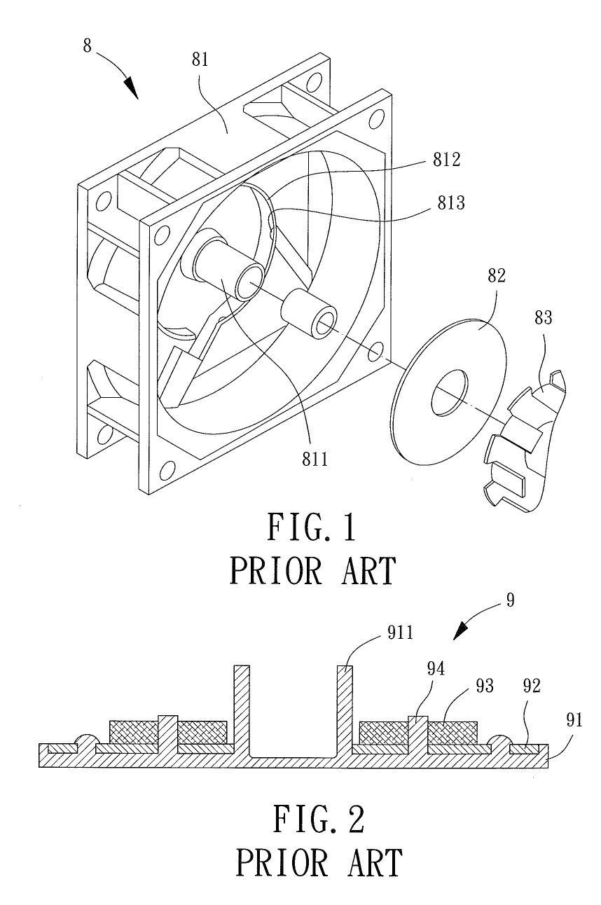

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “lower”, “inner”, “outer”, “end”, “portion”, “section”, “axial”, “annular”, “width”, “height”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

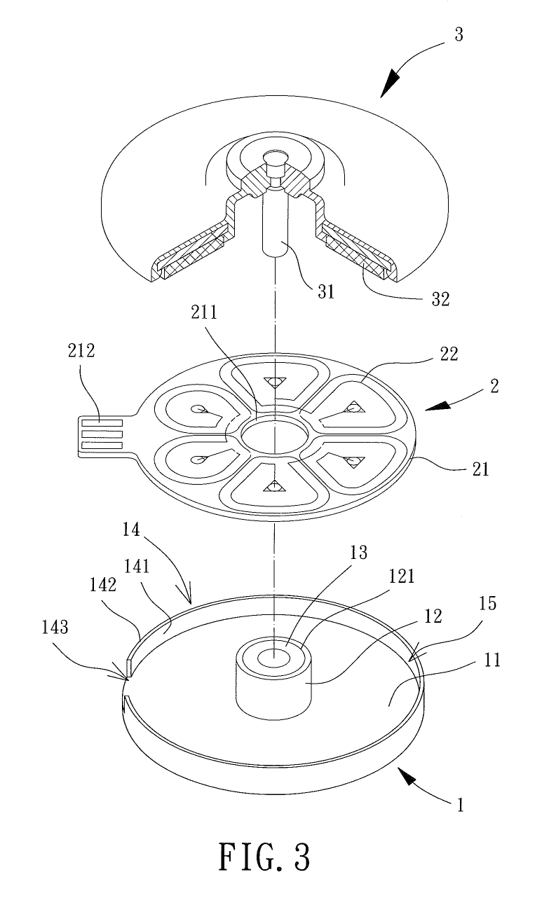

With reference to FIG. 3, a miniature motor according to the present invention includes a base 1, a stator coil unit 2, and a rotating member 3. The stator coil unit 2 is mounted to the base 1 and can be connected to an external power source or driving circuit. The rotating member 3 is rotatably coupled with the base 1. The stator coil unit 2 is utilized to drive the rotating member 3 to rotate.

The base 1 includes an engagement face 11 having a coupling portion 12. The coupling portion 12 can be of any structure allowing rotational coupling of the rotating member 3. In this embodiment, the coupling portion 12 is a shaft tube. An end of the shaft tube distal to the engagement face 11 has an opening 121. Preferably, a bearing 13 is received in the shaft tube.

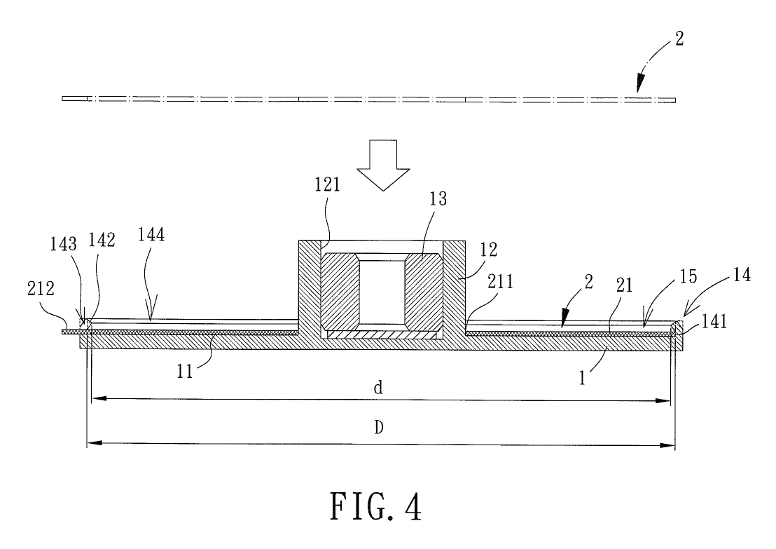

An engaging portion 14 is provided on a periphery of the base 1 surrounding the coupling portion 12. A concave surface 15 is defined between the engaging portion 14 and the coupling portion 12. An inner peripheral wall of the engaging portion 14 facing the coupling portion 12 is a pressing face 141. An end of the engaging portion 14 distal to the engagement face 11 includes a thermoplastic section 142. The thermoplastic section 142 is made of a material that deforms when heated and that takes shape after cooling. The engaging portion 14 can include a plurality of limiting plates, an annular wall, or any structure allowing the stator coil unit 2 to be mounted on the concave surface 15. In the embodiment shown in FIGS. 3 and 4, the engaging portion 14 is an annular wall having a notch 143. When the stator coil unit 2 is mounted on the concave surface 15, the pressing face 141 of the annular wall engages with the stator coil unit 2 to increase the engaging area between the engaging portion 14 and the stator coil unit 2.

The stator coil unit 2 includes a substrate 21 having at least one coil 22. The substrate 21 is mounted on the concave surface 15 of the base 1 and engages with the engagement face 11. In this embodiment, the substrate 21 is a printed circuit board, and the at least one coil 22 is formed on the surface of the substrate 21 by printing circuit board layout or electrical casting to effectively reduce the axial height of the stator coil unit 2. Furthermore, the substrate 21 includes a mounting hole 211. When the substrate 21 is engaged with the engagement face 11 of the base 1, the coupling portion 12 is extended through the mounting hole 211 to provide enhanced assembling convenience. Further, an electrical connection port 212 is provided on a periphery of the substrate 21 and electrically connected to the at least one coil 22. The electrical connection port 212 is engaged in the notch 143 of the engaging portion 14 to provide enhanced positioning effect for the stator coil unit 2. The electrical connection port 212 can be connected to an external power source or a driving circuit to provided assembling convenience when the stator coil unit 2 is connected to the external power source or the driving circuit.

The rotating member 3 is rotatably coupled with the coupling portion 12 of the base 1. In this embodiment, the rotating member 3 includes a shaft 31 extended through the opening 121 and rotatably engaged with the bearing 13. The rotating member 3 further includes a permanent magnet 32, with an air gap formed between the permanent magnet 32 and the stator coil unit 2. When the stator coil unit 2 is energized by the external power source or the driving circuit to create a magnetic field, the magnetic field passes across the air gap and reacts with the permanent magnet 32 to drive the rotating member 3 to rotate.

With reference to FIG. 4, in assembly of the miniature motor according to the present invention, the substrate 21 of the stator coil unit 2 is mounted on the concave surface 15 of the base 1. The substrate 21 is engaged with the engagement face 11 of the base 1. The engaging portion 14 of the base 1 surrounds the substrate 21. Preferably, the outer periphery of the substrate 21 is engaged with the pressing face 141 of the engaging portion 14 to increase the engaging area between the base 1 and the stator coil unit 2.

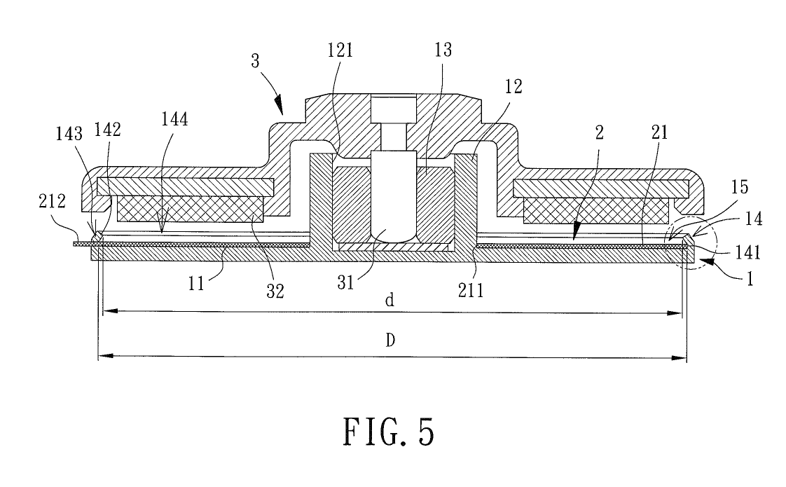

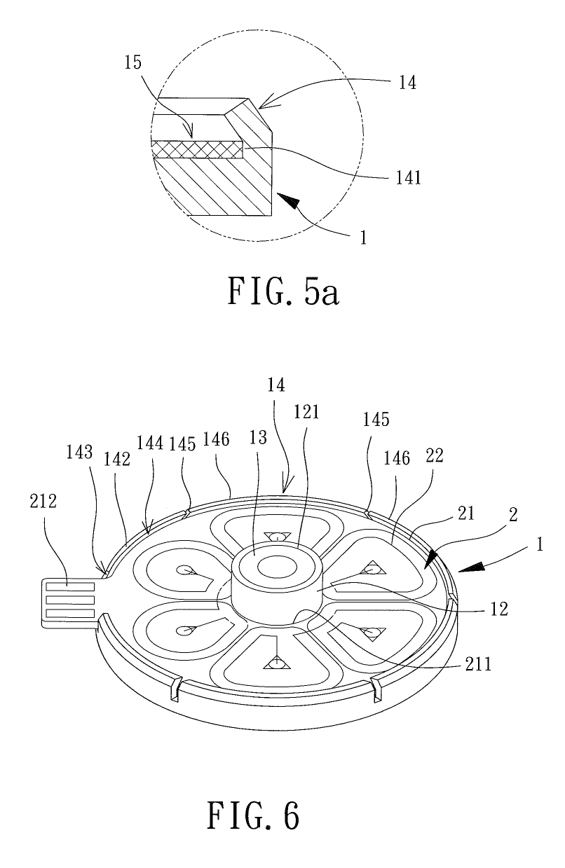

After the stator coil unit 2 is initially engaged in the base 1, a heating tool (not shown) presses against and heats the thermoplastic section 142 of the engaging portion 14. With reference to FIG. 4, the thermoplastic section 142 melts and deforms to form a reduced opening 144 in the engaging portion 14 for retaining the stator coil unit 2. The heating temperature, time, and operational factors for heating and deforming the thermoplastic section 142 can be appreciated by one skilled in the art without detailed description. The heating tool is then moved away from the thermoplastic section 142. With reference to FIGS. 5 and 5A, the deformed thermoplastic section 142 takes shape after cooling. The reduced opening 144 has a diameter d smaller than the maximum outer diameter D of the stator coil unit 2 to reliably retain the stator coil unit 2 on the concave surface 15. Disengagement of the stator coil unit 2 from the base 1 is more effectively prevented by the reduced opening 144.

With reference to FIG. 6, the peripheral wall of the engaging portion 14 can include a plurality of grooves 145, with a limiting plate 146 formed between two adjacent grooves 145. The limiting plates 146 surround and clamp the substrate 21 of the stator coil unit 2. When the heating tool presses against the thermoplastic section 142, the thermoplastic section 142 at top ends of the limiting plates 146 are more liable to be pressed by the heating tool to move and deform towards the center of the stator coil unit 2 to form the reduced opening 144 due to provision of the grooves 145.

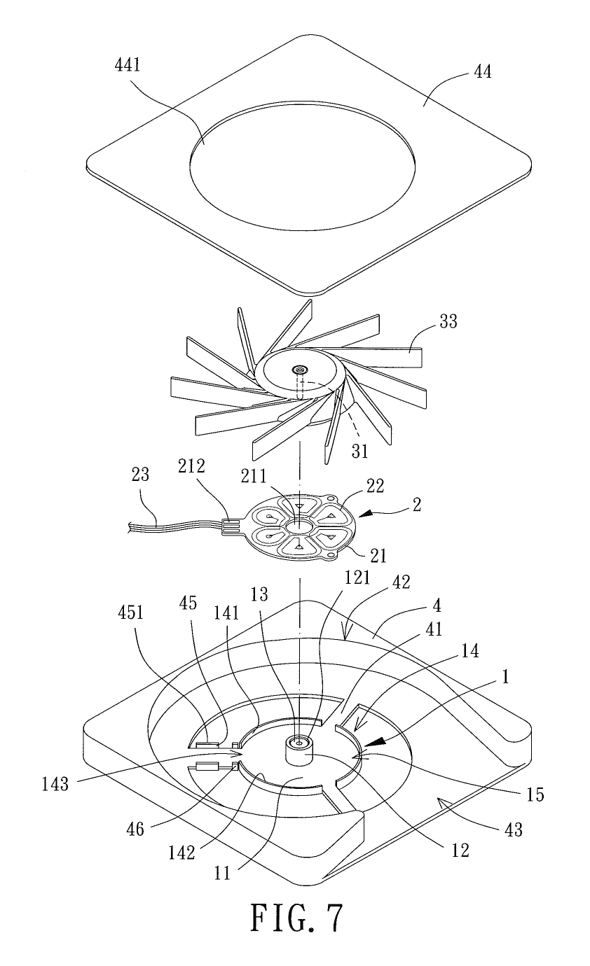

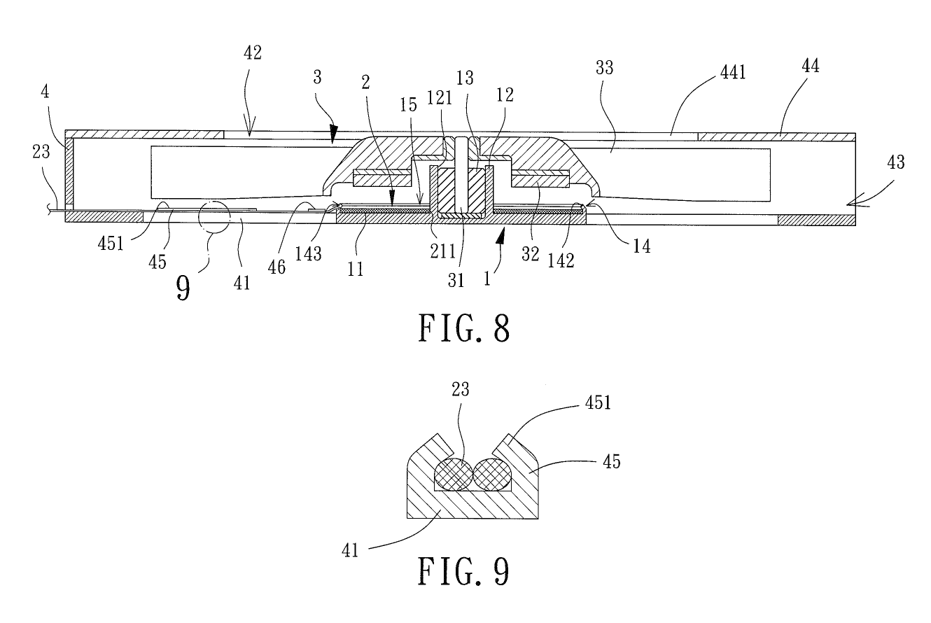

FIGS. 7 and 8 show a cooling fan having the miniature motor according to the present invention. The structural features of the cooling fan identical to those of the miniature motor will not be described to avoid redundancy.

The base 1 of the cooling fan having the miniature motor according to the present invention is connected to a frame 4. Preferably, the base 1 is connected by a plurality of connecting members 41 (such as ribs or static vanes) to the frame 4. The frame 4 includes an air inlet 42 and an air outlet 43. An upper lid 44 is mounted to the frame 4 and includes an opening 441 aligned with the air inlet 42, forming a fan housing. A plurality of blades 33 is formed on an outer periphery of the rotating member 3 to form an impeller. By adding the above features to the base 1, the stator coil unit 2, and the rotating member 3, the cooling fan according to the present invention can be formed to provide predetermined cooling effect when the rotating member 3 rotates.

One of the connecting members 41 includes an auxiliary engaging portion 45 and two clamping plates 46. A thermoplastic section 451 is provided on a top end of the auxiliary engaging portion 45. In this embodiment, the auxiliary engaging portion 45 includes two retaining plates spaced from each other. The coil 22 of the stator coil unit 2 is electrically connected to a power connection unit 23. In this embodiment, the power connection unit 23 is electrically connected to the at least one coil 22 via the electrical connection port 212. With reference to FIG. 9, the power connection unit 23 is preferably engaged in the auxiliary engaging portion 45, with the clamping plates 46 clamping and fixing the power connection unit 23, providing enhanced positioning effect. In this embodiment, the power connection unit 23 is clamped between the retaining plates of the auxiliary engaging portion 45. The thermoplastic section 451 of the auxiliary engaging portion 45 is also heated and deformed by the heating tool. After cooling and taking shape of the thermoplastic section 451, a reduced opening having a width smaller than that of the power connection unit 23 is formed in the thermoplastic section 451 to effectively retain the power connection unit 23, preventing disengagement of the power connection unit 23.

In view of the foregoing, in the miniature motor and the cooling fan having the miniature motor according to the present invention, by providing the thermoplastic section 142 on the engaging portion 14 of the base 1, when assembling the stator coil unit 2 with the base 1, the thermoplastic section 142 can deform through use of a heating tool, and the thermoplastic section 142 takes shape after cooling to form the reduced opening 144. Thus, after the stator coil unit 2 is engaged with the base 1, the stator coil unit 2 can be reliably retained in place by the reduced opening 144, providing enhanced assembling convenience.

In the miniature motor and the cooling fan having the miniature motor according to the present invention, the stator coil unit 2 is mounted on the concave surface 15 of the base 1. The concave surface 15 surrounds the stator coil unit 2 and cooperates with the reduced opening 144 formed by the thermoplastic section 142 and having a diameter d smaller than the maximum outer diameter D of the stator coil unit 2, so that the stator coil unit 2 can be more reliably positioned, preventing the stator coil unit 2 from disengaging from the shaft tube 22 and reducing structural complexity.

As mentioned above, the miniature motor and the cooling fan having the miniature motor according to the present invention provide the stator coil unit 2 with enhanced engagement reliability and provide enhanced assembling convenience.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A miniature motor comprising:
a base including a coupling portion, with an engaging portion provided on a periphery of the base surrounding the coupling portion, with a concave surface formed between the coupling portion and the engaging portion, with the engaging portion including an end having a thermoplastic section;
a stator coil unit including a substrate mounted on the concave surface of the base, with the substrate including at least one coil; and
a rotating member rotatably coupled with the coupling portion of the base, with the rotating member including a permanent magnet, with an air gap formed between the permanent magnet and the stator coil unit,
with the thermoplastic section of the base including a reduced opening, with the reduced opening formed by heating and deforming the thermoplastic section after the stator coil unit is mounted on the concave surface, with the heated and deformed thermoplastic section taking shape to form the reduced opening after cooling.

2. The miniature motor as claimed in claim 1, with the engaging portion being an annular wall surrounding the substrate of the stator coil unit.

3. The miniature motor as claimed in claim 1, with the engaging portion including a plurality of grooves, with a limiting plate formed between two adjacent grooves, with the limiting plates surrounding and clamping the substrate of the stator coil unit.

4. The miniature motor as claimed in claim 1, with the engaging portion of the base including an inner peripheral wall facing the coupling portion, with the inner peripheral wall being a pressing face, with the substrate including an outer periphery engaged with the pressing face.

5. The miniature motor as claimed in claim 1, with the stator coil unit having a maximum diameter, with the reduced opening having a diameter smaller than the maximum diameter of the stator coil unit.

6. The miniature motor as claimed in claim 1, with the substrate of the stator coil unit including a mounting hole, with the coupling portion of the base extending through the mounting hole.

7. The miniature motor as claimed in claim 1, with the engaging portion including a notch, with the stator coil unit including an electrical connection port electrically connected to the at least one coil, with the electrical connection port engaged in the notch of the engaging portion.

8. A cooling fan comprising:
a base including a coupling portion, with the base connected to a frame to form a fan housing, with the frame including an air inlet and an air outlet, with an engaging portion provided on a periphery of the base surrounding the coupling portion, with a concave surface formed between the coupling portion and the engaging portion, with the engaging portion including an end having a thermoplastic section;
a stator coil unit including a substrate mounted on the concave surface of the base, with the substrate including at least one coil; and
a rotating member rotatably coupled with the coupling portion of the base, with the rotating member including a permanent magnet, with an air gap formed between the permanent magnet and the stator coil unit, with the rotating member including a plurality of blades to form an impeller,
with the thermoplastic section of the base including a reduced opening, with the reduced opening formed by heating and deforming the thermoplastic section after the stator coil unit is mounted on the concave surface, with the molten and deformed thermoplastic section taking shape to form the reduced opening after cooling.

9. The cooling fan as claimed in claim 8, with the engaging portion being an annular wall surrounding the substrate of the stator coil unit.

10. The cooling fan as claimed in claim 8, with the engaging portion including a plurality of grooves, with a limiting plate formed between two adjacent grooves, with the limiting plates surrounding and clamping the substrate of the stator coil unit.

11. The cooling fan as claimed in claim 8, with the base connected to the frame by a plurality of connecting members.

12. The cooling fan as claimed in claim 11, with the at least one coil of the stator coil unit electrically connected to a power connection unit, with one of the plurality of connecting members including an auxiliary engaging portion having a second thermoplastic section, with the second thermoplastic section of the auxiliary engaging portion including a second reduced opening, with the second reduced opening of the auxiliary engaging portion retaining the power connection unit, with the second reduced opening having a width smaller than a width of the power connection unit.

13. The cooling fan as claimed in claim 12, with the auxiliary engaging portion including two retaining plates spaced from each other, with the power connection unit clamped between the two retaining plates of the auxiliary engaging portion.

14. The cooling fan as claimed in claim 11, with one of the plurality of connecting members including two clamping plates, with the two clamping plates clamping and fixing the power connection unit.

15. The cooling fan as claimed in claim 8, with the engaging portion of the base including an inner peripheral wall facing the coupling portion, with the inner peripheral wall being a pressing face, with the substrate including an outer periphery engaged with the pressing face.

16. The cooling fan as claimed in claim 8, with the stator coil unit having a maximum diameter, with the reduced opening having a diameter smaller than the maximum diameter of the stator coil unit.

17. The cooling fan as claimed in claim 8, with the substrate of the stator coil unit including a mounting hole, with the coupling portion of the base extending through the mounting hole.

18. The cooling fan as claimed in claim 8, with the engaging portion including a notch, with the stator coil unit including an electrical connection port electrically connected to the at least one coil, with the electrical connection port engaged in the notch of the engaging portion.
